(19) United States
(12) Patent Application Publication
(10) Pub. No.: US 2009/0199775 A1
(43) Pub. Date: Aug. 13, 2009

(54) COLLAPSIBLE PET FEEDER

(76) Inventor: Ellis N. Shamoon, Dallas, TX (US)

Correspondence Address: Daniel V. Thompson;Thompson & Gustavson, LLP, 9304 Forest Lane, Suite N253, Dallas, TX, 75243, US

(21) Appl. No.: 12/030,731

(22) Filed: Feb. 13, 2008

(51) Int. Cl. A01K 5/01

(52) U.S. Cl. 119/61.56; 119/51.01

(57) ABSTRACT

A collapsible pet feeder includes a rigid annular portion maintaining the shape of the opening s of a pair of bowls, secured to a cup portion formed of a flexible material, such as silicone. A set of movable legs secures to the annular portion which fold downward to elevate the pet feeder during use, and fold upwards to facilitate a thin-profile storage configuration.

### BACKGROUND OF THE INVENTION

This invention relates to the field of caring for pets, and provides a portable apparatus for supplying liquids or food to a pet.

Pet owners often face the problem of properly caring for their pet while traveling. Since pet supplies must share space with other traveling essentials, space is at a premium. Existing pet bowls and feeders are designed to withstand the rigors of pet ownership and often incorporate features that make the product more durable, spill-resistant or immovable. While such features are ideal for feeders intended for non-portable use they also add considerable bulk and weight, making the feeder inconvenient for travel.

The present invention provides a solution to these problems in the form of a durable pet feeder with collapsible membrane bowls that allow for thin-profile storage without sacrificing capacity, and folding legs that extend to elevate the feeder to a level more comfortable for pets, and collapse to allow for a thin-profile storage configuration.

In the embodiment of the invention shown herein, a rigid support frame with a pivotally connected set of legs provides a set of flexible membrane bowls that are shaped to facilitate the novel function of the invention. The bowls are removable and interchangeable, allowing the user to make modular changes or use the bowls separately as needed. The pivoting legs are attached at the perimeter of the rigid support frame and may be manually rotated upward so that they become parallel with the support frame. These features allow a set of fully-sized pet bowls to fit in an unusually small storage space.

### BRIEF DESCRIPTION OF THE DRAWINGS

A more complete understanding of the invention and its advantages will be apparent from a review of the Detailed Description in conjunction with the following Drawings, in which:

FIG. 1 is a perspective view of a collapsible pet feeder in the use configuration which includes the present invention.

FIG. 2 is a rear view of the pet feeder of FIG. 1.

FIG. 3 is a top view of the pet feeder of FIG. 1.

FIG. 4 is a bottom view of the pet feeder of FIG. 1.

FIG. 5 is a side view of the pet feeder of FIG. 1.

FIG. 6 is a side view of the pet feeder in its storage configuration.

FIG. 7 is a bottom perspective view of the pet feeder of FIG. 6.

### DETAILED DESCRIPTION

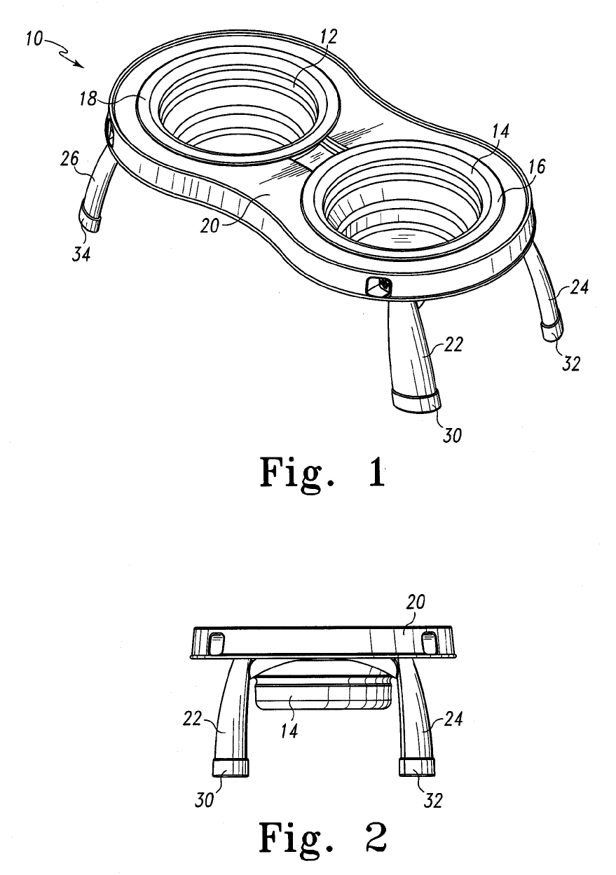

Referring initially to FIGS. 1-7, where like numerals indicate like and corresponding elements, pet feeder 10 includes at least two flexible, integrally elastomeric membranes 12, 14 each supported by a rigid support frame 16, 18, respectively, about a perimeter of the membrane. “Flexible” is used in its ordinary sense to mean easily bendable.

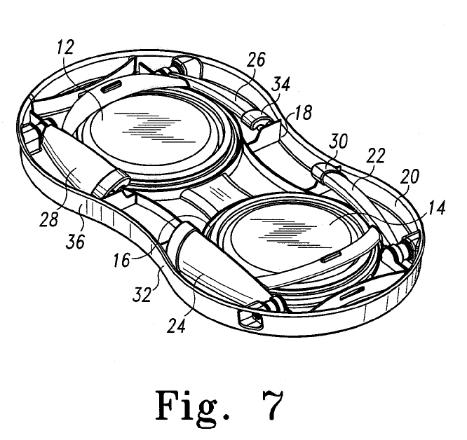

The membranes 12, 14 have at least two selectable membrane configurations, as shown in FIGS. 1 and 7. The two selectable configurations are an extended use configuration (FIGS. 1-5) and a near-flat storage configuration (FIGS. 6 and 7). In the storage configuration (FIGS. 6 and 7), the membranes 12, 14 are approximately the same width as frames 16, 18. In the use configuration (FIGS. 1-5), membranes 12, 14 are extended from frames 16, 18 to form a set of open-topped containers or bowls. The membranes 12, 14 may alternatively be attached integrally to the support frame 20, or as illustrated in this embodiment, be each attached to a separate modular rigid support frame 16, 18 that fits within the main support frame 20.

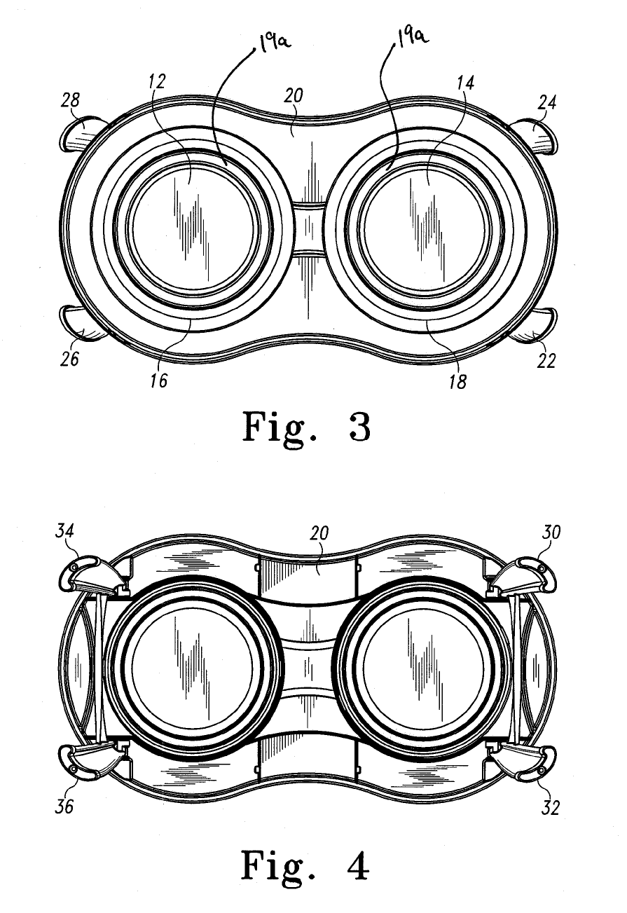

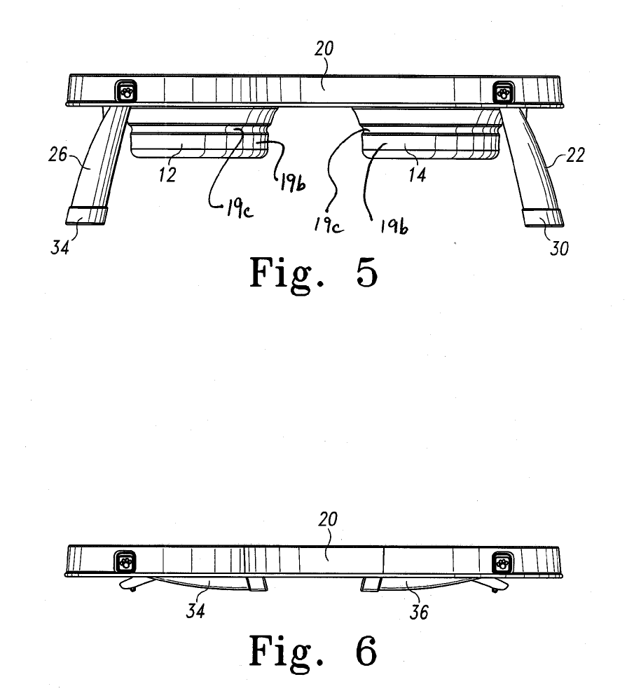

The membranes 12, 14 each have having an inner and outer surface 19a (FIG. 3) and 19b (FIG. 5), respectively, the inner surface 19a being substantially smooth when the membrane 12, 14 is in the use configuration, and the outer surface 19b having at least one inwardly-concave hinge area 19c (FIG. 5) when the membrane 12, 14 is folded in the storage configuration.

A key feature of the invention is that the membranes 12, 14 are formed to be stable in both the storage and use configurations. This enables the user to select either configuration which the membranes 12, 14 will then statically hold indefinitely until it is shifted to the other configuration. One example of the membrane 12, 14 is formed of silicone rubber.

Another key feature is a set of movable legs 22, 24, 26, 28 pivotally-connected to the main support frame 20. In the use configuration (FIGS. 1-5), the legs 22, 24, 26, 28 have been pivoted substantially perpendicular to the support frame and downward to the floor contact surface plane. The legs each incorporate a non-slip surface 30, 32, 34, 36 where the leg meets the floor contact surface plane. In the storage configuration the legs 22, 24, 26, 28 have been pivoted inward, substantially parallel to the plane of main support frame 20.

In operation, in its storage configuration, each flexible membrane is in a near flat shape, suspended at its perimeter by a modular rigid support frame which in turn fits within the main rigid support frame. For use, the pet feeder is taken out of its storage space and the user manually folds the pivoting legs downward while gripping the main support frame. Once the legs are in place, the feeder is placed on a flat surface such as a floor or countertop, where the user then extends the collapsible bowls by exerting downward pressure upon the membranes. The pet feeder can then be used for pet care purposes in a manner consistent with the prior art. When the cup is ready for storage, the user simply reverses the process for use preparation.

While the invention has been illustrated and described as embodied one type of pet feeder, it is not intended to be limited to the details shown, since it will be understood that various omissions, modifications, substitutions and changes in the forms and details of the device illustrated in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A pet feeder, comprising at least two flexible membranes.

2. The pet feeder of claim 1 where the membranes are formed of an elastomeric material and have at least two selectable configurations.

3. The pet feeder of claim 2 where the two selectable configurations are a near-flat storage configuration and a use configuration where the membrane forms an open-topped container.

4. The pet feeder of claim 3 where the membranes having an inner and outer surface, the inner surface being substantially smooth when the membrane is in the use configuration, and the outer surface having at least one inwardly-concave hinge area where the membrane is folded in the storage configuration.

5. The pet feeder of claim 1 with the membranes supported by a rigid support frame about a perimeter of each membrane.

6. The pet feeder of claim 5 with a set of movable legs pivotally-connected to the support frame.

7. The pet feeder of claim 6 with the legs having at least two selectable configurations.

8. The pet feeder of claim 7 where at least two selectable leg configurations include a storage configuration where the legs are substantially parallel to the support frame, and a use configuration where the legs are pivoted substantially perpendicular to the support frame.

9. The pet feeder of claim 7 where the legs having a floor-contact end, with the end incorporating a non-slip surface.

10. A pet feeder, comprising:
at least two flexible, integrally elastomeric membranes;
where the membranes have at least two selectable configurations;
where the two selectable membrane configurations are a near-flat storage configuration and a use configuration wherein the membrane forms an open-topped container;
where the membranes are supported by a rigid support frame about a perimeter of each membrane.

11. The pet feeder of claim 10 with a set of movable legs pivotally-connected to the support frame.

12. The pet feeder of claim 11 with the legs having at least two selectable configurations.

13. The pet feeder of claim 12 where at least two selectable leg configurations include a storage configuration where the legs are substantially parallel to the support frame, and a use configuration where the legs are pivoted substantially perpendicular to the support frame.

14. The pet feeder of claim 12 where the legs having a floor-contact end, with the end incorporating a non-slip surface.

15. A pet feeder, comprising:
At least two flexible, integrally elastomeric membranes;
the membranes having at least two selectable membrane configurations;
where the two selectable configurations are a near-flat storage configuration and a use configuration where the membrane forms an open-topped container;
the membranes having an inner and outer surface, the inner surface being substantially smooth when the membrane is in the use configuration, and the outer surface having at least one inwardly-concave hinge area where the membrane is folded in the storage configuration;
the membranes supported by a rigid support frame about a perimeter of each membrane; and
a set of movable legs pivotally-connected to the support frame.

16. The pet feeder of claim 15 with the legs having at least two selectable leg configurations;

17. The pet feeder of claim 16 where at least two selectable leg configurations include a storage configuration where the legs are substantially parallel to the support frame, and a use configuration where the legs are pivoted substantially perpendicular to the support frame.

18. The pet feeder of claim 17 with the legs having a floor-contact end, with the end incorporating a non-slip surface.

19. A pet feeder, comprising:
at least two flexible, integrally elastomeric membranes;
the membranes having at least two selectable membrane configurations;
where the two selectable configurations are a near-flat storage configuration and a use configuration where the membrane forms an open-topped container;
the membranes each having an inner and outer surface, the inner surface being substantially smooth when the membrane is in the use configuration, and the outer surface having at least one inwardly-concave hinge area where the membrane is folded in the storage configuration;
the membranes supported by a rigid support frame about a perimeter of each membrane;
a set of movable legs pivotally-connected to the support frame;
the legs having at least two selectable leg configurations;
where the at least two selectable leg configurations include a storage configuration where the legs are substantially parallel to the support frame, and a use configuration where the legs are pivoted substantially perpendicular to the support frame; and
with the legs each having a floor-contact end, with the end incorporating a non-slip surface.
